(19) United States
(12) Patent Application Publication
(10) Pub. No.: US 2025/0372602 A1
(43) Pub. Date: Dec. 4, 2025

(54) ELECTRODE SHEET MANUFACTURING DEVICET AND ELECTRODE SHEET MANUFACTURING METHOD

(71) Applicants: Prime Planet Energy & Solutions, Inc., Tokyo (JP); TOYOTA JIDOSHA KABUSHIKI KAISHA, Aichi-ken (JP)

(72) Inventors: Shinji YOSHIOKA, Himeji-shi (JP); Toshiatsu ODAI, Himeji-shi (JP); Shota HIROHATA, Kasai-shi (JP); Yuuki TOYOSHIMA, Himeji-shi (JP); Hiroyoshi YAMAMOTO, Himeji-shi (JP); Katsuya SHIOZAKI, Kakogawa-shi (JP); Daichi UMINO, Himeji-shi (JP); Joji SHITARA, Himeji-shi (JP); Tomofumi HIRUKAWA, Toyota-shi (JP); Kengo HAGA, Nagoya-shi (JP); Yuki MASUDA, Kariya-shi (JP)

(21) Appl. No.: 19/215,330

(22) Filed: May 22, 2025

(30) Foreign Application Priority Data
May 28, 2024 (JP) 2024-086696

(51) Int. Cl. H01M 4/04

(52) U.S. Cl. CPC H01M 4/0435

(57) ABSTRACT

An electrode sheet manufacturing device manufactures an electrode sheet including a current collector, a non-formed portion, an electrode active material layer, and a protective layer. The electrode sheet manufacturing device includes a conveyance device, a support roll, a press roll, and a driving device. The press roll is arranged so as to be opposed to the support roll. The press roll includes a shaft portion and a rubber portion. The rubber portion is wound around an outer peripheral surface of the shaft portion at least in an area that contacts the non-formed portion. A thickness of the rubber portion in a position that overlaps with an inner end of the non-formed portion is smaller than a thickness of the rubber portion in an area at a more outer side than the position that overlaps with the inner end.

### CROSS REFERENCE OF RELATED APPLICATION

The present application claims priority from Japanese Patent Application No. 2024-086696 filed on May 28, 2024, which is incorporated by reference herein in its entirety.

### BACKGROUND

The present disclosure relates to an electrode sheet manufacturing device and an electrode sheet manufacturing method.

Japanese Laid-open Patent Publication No. 2023-36089 discloses a manufacturing method for an electrode, the method including a preparing step of preparing an electrode sheet, a coated portion pressing step of pressing a coated portion in a thickness direction, and a non-coated portion pressing step of pressing a non-coated portion in the thickness direction. In the non-coated portion pressing step, the non-coated portion is pressed by an elastic roll including a shaft body and an elastic body that covers the shaft body. In the non-coated portion pressing step, the non-coated portion is roll-pressed using a pair of elastic rolls while being pressed in the thickness direction. According to the manufacturing method described above, the non-coated portion can be extended while suppressing a break.

### SUMMARY

A degree of stretchability of a current collector of an electrode sheet can differ in accordance with a position. When stretch of the current collector is nonuniform, quality of the electrode sheet can be affected.

An electrode sheet manufacturing device disclosed herein is a manufacturing device that manufactures an electrode sheet, and the electrode sheet includes a current collector, a non-formed portion, an electrode active material layer, and a protective layer. The current collector is formed of a long metal foil. The non-formed portion is set along a length direction in a preset position of the current collector in a width direction. The electrode active material layer is formed in a portion of the current collector excluding the non-formed portion. The protective layer is formed along a length direction of the electrode active material layer. The electrode sheet manufacturing device includes a conveyance device, a support roll, a press roll, and a driving device. The conveyance device conveys the long electrode sheet along a preset conveyance path. The support roll is arranged on the conveyance path. The support roll supports a first surface of the electrode sheet that is conveyed along the conveyance path along the width direction. The press roll is arranged to be opposed to the support roll on a second surface of the electrode sheet. The driving device presses the press roll to the support roll with the electrode sheet interposed therebetween. The electrode sheet includes the current collector, the electrode active material layer, and the protective layer. The current collector is formed of a metal foil. The electrode active material layer is formed on the current collector. The protective layer is formed along a longitudinal direction of the electrode active material layer. A non-formed portion in which the electrode active material layer and the protective layer are not applied is provided in an end portion of the electrode sheet. The press roll includes a shaft portion and a rubber portion. The rubber portion is wound around an outer peripheral surface of the shaft portion at least in an area that contacts the non-formed portion. A thickness of the rubber portion in a position that overlaps with an inner end of the non-formed portion is smaller than a thickness of the rubber portion in an area at a more outer side than the position that overlaps with the inner end. According to the electrode sheet manufacturing device described above, stretch of the current collector of the electrode sheet can be easily made uniform, and quality of the electrode sheet is likely to be increased.

### BRIEF DESCRIPTION OF THE DRAWINGS

FIG. 1 is a flowchart of manufacturing performed by an electrode sheet manufacturing device 1.

FIG. 2 is a schematic view of an electrode sheet 10.

FIG. 3 is a schematic side view of the electrode sheet manufacturing device 1.

FIG. 4 is a front view of a roll press machine 50.

FIG. 5 is a cross-sectional view illustrating a cross section taken along the line A-A in FIG. 4.

FIG. 6 is a schematic view illustrating a positional relationship between an electrode sheet 10, a support roll 60, and a press roll 70.

FIG. 7 is a schematic view illustrating a relationship between a thickness of rubber and a deformation amount.

FIG. 8 is a schematic view illustrating a roll press machine 150 according to another embodiment.

FIG. 9 is a schematic view illustrating a roll press machine 250 according to still another embodiment.

### DETAILED DESCRIPTION OF THE EMBODIMENTS

Embodiments of a technology disclosed herein will be described below with reference to the accompanying drawings. As a matter of course, the embodiments described herein are not intended to be particularly limiting the present disclosure. The accompanying drawings are schematic and do not necessarily reflect actual members or portions. Members/portions that have the same effect will be denoted by the same sign as appropriate, and the overlapping description will be omitted as appropriate.

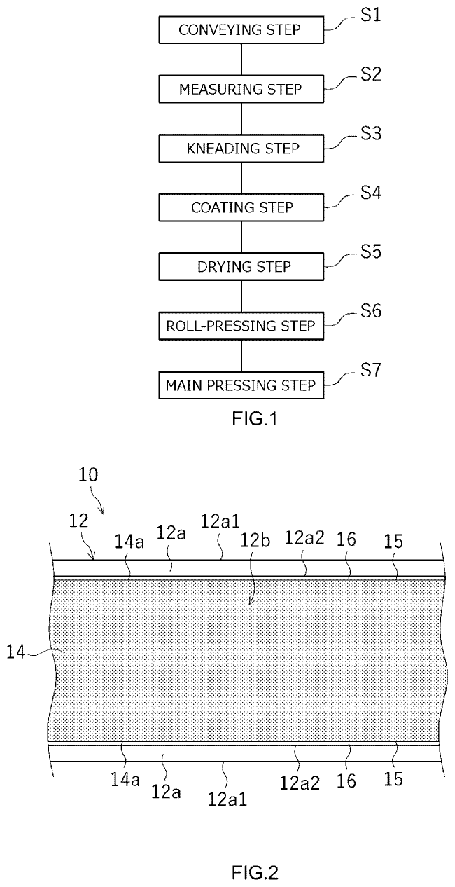

FIG. 1 is a flowchart of manufacturing performed by an electrode sheet manufacturing device 1. As illustrated in FIG. 1, manufacturing performed by the electrode sheet manufacturing device 1 includes a preparing step S1 to S5, a roll-pressing step S6, and a main pressing step S7. In this embodiment, the preparing step includes a conveying step S1, a measuring step S2, a kneading step S3, a coating step S4, and a drying step S5. However, the manufacturing performed by the electrode sheet manufacturing device 1 may include some other step.

### Electrode Sheet Manufacturing Device 1

The electrode sheet manufacturing device 1 manufactures an electrode sheet 10 (see FIG. 2) that forms an electricity storage device. The electrode sheet 10 forms a positive electrode sheet or a negative electrode sheet of an electrode body that is stored in the electricity storage device. The term “electricity storage device” refers to a device that can be charged and discharged repeatedly, and expresses a concept encompassing so-called storage batteries (that is, chemical batteries), such as lithium-ion secondary batteries, nickel-hydrogen batteries, nickel-cadmium batteries, or the like, as well as capacitors (that is, physical batteries), such as electrical double-layer capacitors or the like. As an example, along with a configuration of the electrode sheet 10 used for a lithium-ion secondary battery, the electrode sheet manufacturing device 1 that manufactures the electrode sheet 10 will be described below.

### Electrode Sheet 10

FIG. 2 is a schematic view of the electrode sheet 10. As illustrated in FIG. 2, the electrode sheet 10 includes a current collector 12, an electrode active material layer 14, and a protective layer 16. The current collector 12 is a member formed of a metal foil. The current collector 12 is a long band-like metal member. As the current collector 12, a metal material having a desired conductivity can be used. As a positive electrode current collector, for example, aluminum, an aluminum alloy, or the like can be used. As a negative electrode current collector, for example, copper, a copper alloy, or the like can be used. A portion of the current collector 12 in a preset position is coated with the electrode active material layer 14. The electrode active material layer 14 is formed at least on one surface of the band-like current collector 12. In this embodiment, the electrode active material layer 14 is formed on both surfaces of the current collector 12. The electrode active material layer 14 is a layer including an electrode active material. As a positive electrode active material, for example, a lithium transition metal composite material can be used. As a negative electrode active material, for example, a carbon material, a silicon-based material, mixed oxides thereof, or the like can be used. The electrode active material layer may include an additive, such as a binder, a conductive material, or the like, other than the electrode active material.

The electrode sheet 10 is formed by applying an electrode mixture slurry that is to be the electrode active material layer 14 to the current collector 12 and drying the applied electrode mixture slurry. A non-coated portion 12a and a coated portion 12b are set in the current collector 12. The non-coated portion 12a is a portion of the current collector 12 in which the electrode active material layer 14 and the protective layer 16 are not applied. The non-coated portion 12a is set along a length direction in a preset position in the electrode sheet 10 in a width direction. The non-coated portion 12a is one example of a non-formed portion set as a portion in which the electrode active material layer 14 and the protective layer 16 are not formed along the length direction in a preset position in the current collector 12 in the width direction. The electrode active material layer 14 is formed in a portion of the current collector 12 excluding the non-coated portion 12a. Herein, the electrode active material layer 14 is applied to the portion of the current collector 12 excluding the non-coated portion 12a and is thus formed. In the embodiment, the non-coated portion 12a is set at each of both ends of the electrode sheet 10 in the width direction. The coated portion 12b is arranged between the both ends of the electrode sheet 10. The electrode mixture slurry is applied to the coated portion 12b. Thus, the electrode active material layer 14 is formed on the coated portion 12b of the current collector 12. That is, the electrode active material layer 14 is arranged between the non-coated portions 12a at the both ends of the electrode sheet 10 in the width direction.

The protective layer 16 is a layer formed along the electrode active material layer 14. The protective layer 16 is provided along the electrode active material layer 14 at a positive electrode side. The protective layer 16 is, for example, a layer having higher resistance than that of the electrode active material layer 14. The protective layer 16 includes, for example, an inorganic particle and a resin (binder). Examples of the inorganic particle includes an inorganic oxide, such as, for example, alumina, boehmite, magnesia, silica, titania, or the like, or the like. Examples of the resin (binder) includes, for example, polyvinylidene fluoride (PVdF) or the like. Alternatively, the protective layer 16 may be a layer formed of resin. The protective layer 16 may be formed so as to include a conductive material, such as a carbon material or the like, as necessary. An effect of suppressing short circuit in an electrode body can be enhanced by providing the protective layer 16.

For example, a thickness of the protective layer 16 is smaller than a thickness of the electrode active material layer 14. When the thickness of the protective layer 16 is smaller than the thickness of the electrode active material layer 14, flexibility of a corner portion at an end portion of the current collector 12 in the longitudinal direction can be increased. Although there is no particular limitation on the thickness of the protective layer 16, the thickness of the protective layer 16 can be, for example, about 0.3 or more and 0.7 or less (for example, about 0.4 or more and 0.6 or less) with respect to the thickness of the electrode active material layer 14.

### Conveyance Device 17

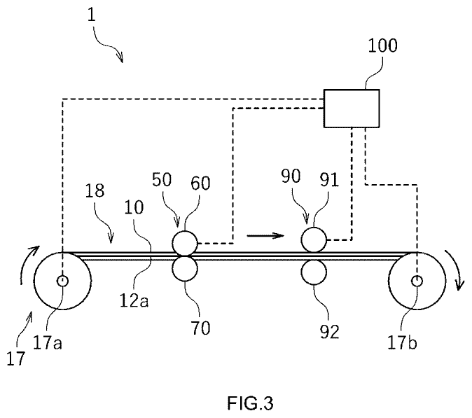

In the conveying step S1 illustrated in FIG. 1, the electrode sheet 10 is conveyed. FIG. 3 is a schematic side view of the electrode sheet manufacturing device 1. The conveying step S1 can be realized by a conveyance device 17. As illustrated in FIG. 3, the conveyance device 17 conveys the long electrode sheet 10. For example, a motor is used for the conveyance device 17. The conveyance device 17 includes an unwinding roll 17a and a winding roll 17b so as to convey the electrode sheet 10 at a preset conveyance speed. The unwinding roll 17a is arranged upstream of the roll press machine 50 in a conveyance direction. The winding roll 17b is arranged downstream of the roll press machine 50 in the conveyance direction. However, the conveyance device 17 is not limited to a configuration with the unwinding roll 17a and the winding roll 17b. For example, the conveyance device 17 may include some other roll than the unwinding roll 17a and the winding roll 17b. The electrode sheet 10 is conveyed along a preset conveyance path 18 by the conveyance device 17.

### Measuring Step S2, Kneading Step S3, Coating Step S4, and Drying Step S5

In the measuring step S2 illustrated in FIG. 1, raw materials of the electrode active material layer 14 (see FIG. 2) are measured. The measuring can be realized, for example, by a measuring device (not illustrated) including a balance, a load cell, or the like. The measured raw materials of the electrode active material layer 14 are mixed in the kneading step S3. The kneading step S3 can be realized by a kneading device (not illustrated). The materials of the electrode active material layer 14 that have been made into a slurry state by the kneading device are applied to the current collector 12 (see FIG. 2) in the coating step S4. The coating step S4 can be realized by, for example, a coating device (not illustrated), such as a slit coater, a gravure coater, a die coater, a comma coater, or the like. In the drying step S5, the applied row material of the electrode active material layer 14 in a slurry state is dried. The drying step S5 can be realized by, for example, a drying device (not illustrated) that emits a hot air, an infrared ray.

### Roll-Pressing Step S6

In the roll-pressing step S6, the electrode sheet 10 is pressed. The roll-pressing step S6 can be realized by the roll press machine 50 illustrated in FIG. 3. As illustrated in FIG. 3, the electrode sheet 10 is pressed by the roll press machine 50 in middle of the conveyance path 18. The electrode sheet 10 is supplied by the unwinding roll 17a. The electrode sheet 10 pressed by the roll press machine 50 is wound by the winding roll 17b. The electrode sheet manufacturing device 1 includes a control device 100 that controls the unwinding roll 17a, the winding roll 17b, and the roll press machine 50.

### Roll Press Machine 50

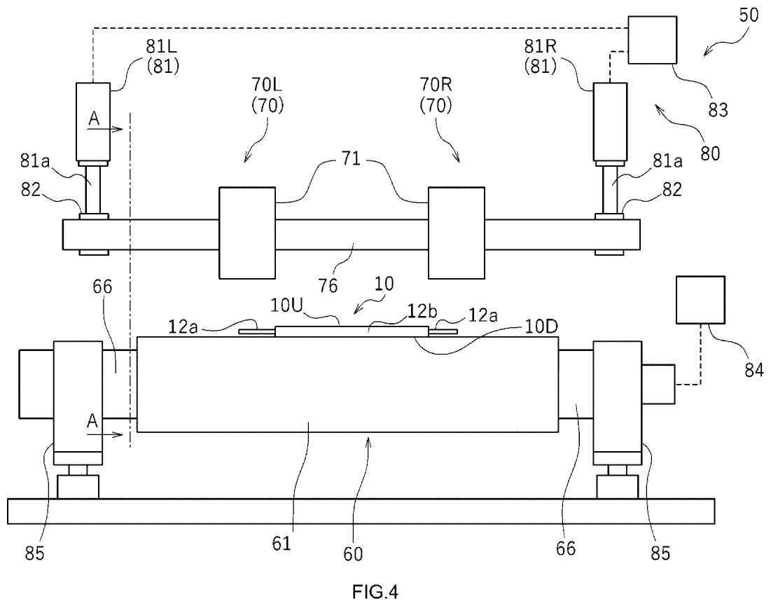

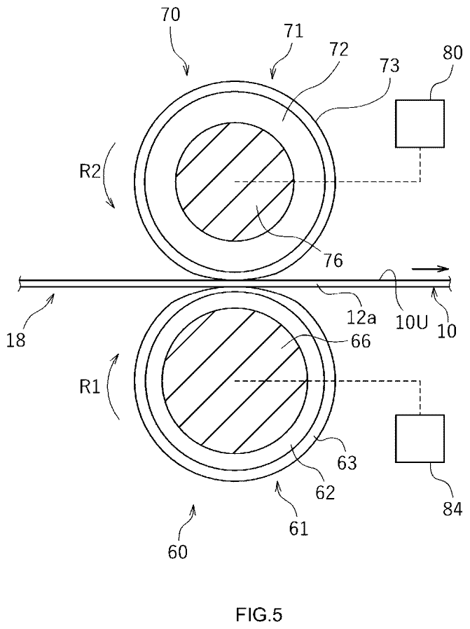

FIG. 4 is a front view of the roll press machine 50. Herein, the roll press machine 50 according to this embodiment is a device that presses the non-coated portion 12a of the electrode sheet 10 by rubber rolls before and after pressing the coated portion 12b. When the non-coated portion 12a is pressed by the rubber rolls, the non-coated portion 12a receives reaction forces of elastic deformation and compressive deformation of the rubber rolls, and a portion thereof pushed by the rolls is pressed and is also pulled. As a result, the non-coated portion 12a can be stretched while a break of the non-coated portion 12a is suppressed. Because of a function described above, the device that presses the non-coated portion 12a of the electrode sheet 10 by the rubber rolls can be referred to as an elasticity powered stretching (EPS) device, as appropriate. The electrode sheet manufacturing device 1 may include, in addition to the roll press machine 50, a device that presses the coated portion 12b of the electrode sheet 10.

The roll press machine 50 includes a support roll 60, a press roll 70, and a press pressure regulating mechanism 80.

### Support Roll 60

The support roll 60 is arranged on the conveyance path 18 (see FIG. 3). The support roll 60 supports a surface 10D of the electrode sheet 10 that is conveyed along the conveyance path 18 along a width direction of the electrode sheet 10. The surface 10D is one example of a first surface in the present disclosure. The support roll 60 is arranged under the press roll 70. The support roll 60 is a rubber roll that presses the non-coated portion 12a of the electrode sheet 10 with the press roll 70. The support roll 60 includes a body portion 61 and a both shaft portion 66.

FIG. 5 is a cross-sectional view of a cross section taken along the line A-A of FIG. 4. However, in FIG. 5, a state when the non-coated portion 12a is pressed by the support roll 60 and the press roll 70 is illustrated. As illustrated in FIG. 5, the body portion 61 of the support roll 60 includes a shaft portion 62 and a rubber portion 63. The shaft portion 62 is made of metal. Although there is no particular limitation on a material that forms the shaft portion 62, for example, the material that forms the shaft portion 62 is a material having a relatively high hardness, such as SUS304 (stainless steel). The rubber portion 63 is arranged so as to cover at least an outer peripheral surface of the shaft portion 62. A material that forms the rubber portion 63 is, for example, nitrile rubber (NBR). The support roll 60 presses the non-coated portion 12a of the electrode sheet 10 by the rubber portion 63.

The support roll 60 is rotated in a predetermined direction by a roll driving device 84 (see FIG. 4) that will be described later. In this embodiment, the support roll 60 rotates in a direction of an arrow R1 illustrated in FIG. 5. At this time, the electrode sheet 10 is conveyed from left to right as viewed in FIG. 5. That is, left in FIG. 5 is an upstream side in the conveyance direction, and right in the FIG. 5 is a downstream side in the conveyance direction.

As illustrated in FIG. 4, the both shaft portion 66 is inserted in the body portion 61. The both shaft portion 66 is inserted in the shaft portion 62 of the body portion 61 (see FIG. 5). The both shaft portion 66 extends so as to reach outside of the support roll 60 in a shaft direction. Note that, although not illustrated, a bearing, a gap screw that adjusts a gap between the support roll 60 and the press roll 70, or the like are attached to the both shaft portion 66.

### Press Roll 70

As illustrated in FIG. 5, the press roll 70 is arranged so as to be opposed to the support roll 60 on an upper surface 10U of the electrode sheet 10. The press roll 70 is arranged such that the non-coated portion 12a is interposed between the press roll 70 and the support roll 60, except the coated portion 12b of the electrode sheet 10 (see FIG. 2). The upper surface 10U is one example of a second surface in the present disclosure. A center position of the press roll 70 in the shaft direction and a center position of the support roll 60 in the shaft direction are arranged to be aligned in an up-down direction. As illustrated in FIG. 4, the press roll 70 is a rubber roll that presses the non-coated portion 12a of the electrode sheet 10 with the support roll 60. The press roll 70 is not arranged over the coated portion 12b of the electrode sheet 10. In this embodiment, as described above, the non-coated portion 12a of the electrode sheet 10 is set each of the both ends of the electrode sheet 10 in the width direction. Therefore, as illustrated in FIG. 4, the press roll 70 is arranged over each of the non-coated portions 12a arranged at the both ends of the electrode sheet 10 in the width direction. However, in a case where the number of the non-coated portions 12a is one, the number of the press rolls 70 may be one. One of the two press rolls 70 that is arranged at left is also referred to as a press roll 70L, and the other one of the two press rolls 70 that is arranged at right is also referred to as a press roll 70R. However, in description that applies to each of the press rolls 70L and 70R, the name of the press roll 70 is used as appropriate. The press roll 70 includes a body portion 71 (see FIG. 5) and a both shaft portion 76.

As illustrated in FIG. 5, the body portion 71 of the press roll 70 includes a shaft portion 72 and a rubber portion 73. The shaft portion 72 is made of metal. Although there is no particular limitation on a material that forms the shaft portion 72, for example, the material that forms the shaft portion 72 is a material having a relatively high hardness, such as SUS304 (stainless steel). The rubber portion 73 is arranged so as to cover at least an outer peripheral surface of the shaft portion 72. Although there is no particular limitation on a material that forms the rubber portion 73, for example, the material that forms the rubber portion 73 is nitrile rubber (NBR). The press roll 70 presses the non-coated portion 12a of the electrode sheet 10 by the rubber portion 73.

As illustrated in FIG. 4, the both shaft portion 76 is inserted in the body portion 71. The both shaft portion 76 is inserted in the shaft portion 72 of the body portion 71 (see FIG. 5). The both shaft portion 76 extends so as to reach outside of each of the two press rolls 70 in the shaft direction. Note that, although not illustrated, a bearing, a gap screw that adjusts a gap between the support roll 60 and the press roll 70, or the like is attached to the both shaft portion 76.

As illustrated in FIG. 5, the electrode sheet 10 is interposed between the support roll 60 and the press roll 70 and, when the support roll 60 rotates in the direction of the arrow R1, the press roll 70 receives a force that rotates in a direction of an arrow R2 via the electrode sheet 10. Alternatively, when the electrode sheet 10 is not arranged between the support roll 60 and the press roll 70 and the support roll 60 and the press roll 70 contact each other, the press roll 70 receives a force that rotates in the direction of the arrow R2 due to a rotating force of the support roll 60. Thus, the press roll 70 rotates in the direction of the arrow R2. That is, the press roll 70 rotates following rotation of the support roll 60.

As illustrated in FIG. 4, the press pressure regulating mechanism 80 includes a press cylinder 81, a roll chock 82, a cylinder driving device 83, the roll driving device 84, and a supporting portion 85.

The press cylinder 81 presses the press roll 70 to the support roll 60. One press cylinder 81 is arranged at a more outer side than each of both ends of the press roll 70. Herein, in FIG. 4, the press cylinder 81 arranged at left of the electrode sheet 10 is also referred to as a press cylinder 81L and the press cylinder 81 arranged at right of the electrode sheet 10 is also referred to as a press cylinder 81R. However, in a case where a common item for the press cylinders 81L and 81R is described, the press cylinders 81L and 81R are referred to as the press cylinders 81. In this embodiment, the press cylinder 81 is a pneumatic cylinder. The press cylinder 81 includes a rod 81a. The rod 81a is connected to the roll chock 82. The roll chock 82 is a member that rotatably supports the both shaft portion 76 of the press roll 70. When the press cylinder 81 is driven and the rod 81a is lowered, the press roll 70 is lowered. When the press cylinder 81 is driven and the rod 81a is lifted, the press roll 70 is lifted.

The cylinder driving device 83 is a device that presses the press roll 70 to the support roll 60 with the electrode sheet 10 interposed between the press roll 70 and the support roll 60. The cylinder driving device 83 is one example of a driving device in the present disclosure. The cylinder driving device 83 is connected to the press cylinder 81. The cylinder driving device 83 drives the press cylinder 81. Thus, the rod 81a of the press cylinder 81 is lifted and lowered. In this embodiment, the cylinder driving device 83 is configured to independently drive each of the press cylinder 81L and the press cylinder 81R. That is, the cylinder driving device 83 independently drives each of the press rolls 70 arranged over a corresponding one of the non-coated portion 12a arranged at the both ends of the electrode sheet 10 in the width direction. The cylinder driving device 83 is connected to the control device 100 (see FIG. 3).

The roll driving device 84 is connected to the support roll 60. The roll driving device 84 is a device that rotates the support roll 60. In this embodiment, the roll driving device 84 rotates the support roll 60 in the direction of the arrow R1 illustrated in FIG. 5. Although there is no particular limitation on a configuration of the roll driving device 84, for example, the roll driving device 84 is configured of an electric motor, a gear, or the like. The roll driving device 84 is connected to the control device 100 (see FIG. 3). Note that the roll driving device 84 may be a device that rotates the press roll 70.

The supporting portion 85 is a member that supports the support roll 60. The supporting portion 85 supports the both shaft portion 66 of the support roll 60.

The support roll 60 and the press roll 70 that form the roll press machine 50 will be described below with the electrode sheet 10 that is to be pressed.

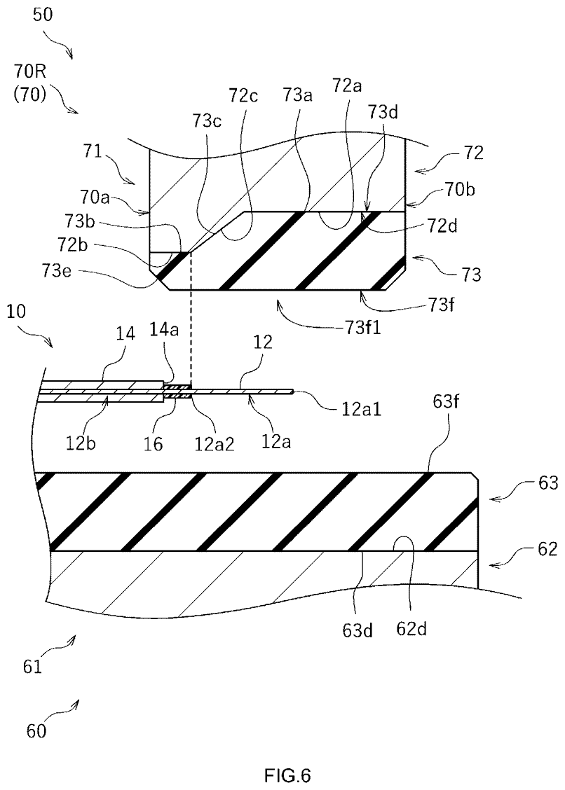

FIG. 6 is a schematic view illustrating a positional relationship between the electrode sheet 10, the support roll 60, and the press roll 70. In FIG. 6, the electrode sheet 10, the support roll 60, and the press roll 70 are virtually illustrated as being separated from each other. In FIG. 6, cross sections of the electrode sheet 10, the support roll 60, and the press roll 70R at right are illustrated. A configuration of the press roll 70L at left can be made similar to a configuration of the press roll 70R at right, and therefore, detailed description thereof will be omitted.

### Support Roll 60

As illustrated in FIG. 6, the support roll 60 (in this embodiment, the body portion 61) includes the shaft portion 62 and the rubber portion 63. An outer diameter of the support roll 60 is approximately constant.

### Shaft Portion 62

The shaft portion 62 is an approximately columnar member that extends along the width direction of the electrode sheet 10. In this embodiment, a diameter of the shaft portion 62 is approximately constant. The rubber portion 63 is wound around the outer peripheral surface 62d of the shaft portion 62. A thickness of the rubber portion 63 is approximately constant, except for a both end portion thereof along a shaft of the support roll 60.

### Rubber Portion 63

The rubber portion 63 is formed into an approximately cylindrical shape. An inner peripheral surface 63d of the rubber portion 63 corresponds to the outer peripheral surface 62d of the shaft portion 62. An inner diameter of the rubber portion 63 is same as an outer diameter of the shaft portion 62. In this embodiment, similar to the outer diameter of the shaft portion 62, the inner diameter of the rubber portion 63 is approximately constant. The electrode sheet 10 is supported by an outer peripheral surface 63f of the rubber portion 63. The non-coated portion 12a of the electrode sheet 10 is pressed by the press roll 70. There is no particular limitation of a thickness of the rubber portion 63. In this embodiment, the thickness of the rubber portion 63 is set to be about same as a thickness of a thick portion 73a that will be described later. The thickness of the rubber portion 63 can be set to be, for example, 0.9 times the thickness of the thick portion 73a or more and 1.1 times the thickness of the thick portion 73a or less.

### Press Roll 70

The press roll 70 (in this embodiment, the body portion 71) includes the shaft portion 72 and the rubber portion 73. A length of the press roll 70 (a dimension along the shaft) is shorter than a length of the support roll 60. Therefore, the electrode sheet 10 is partially sandwiched between the support roll 60 and the press roll 70 and is pressed. The press roll 70 is set to have a dimension with which the press roll 70 can press the non-coated portion 12a of the electrode sheet 10. The length of the press roll 70 is longer than the width of the non-coated portion 12a. In this embodiment, the length of the press roll 70 is about twice the width of the non-coated portion 12a. Although there is no particular limitation, the length of the press roll 70 is preferably about 0.5 times the width of the non-coated portion 12a or more and 2.5 times the width of the non-coated portion 12a or less, and is more preferably about 1.8 times the width of the non-coated portion 12a or more and 2.2 times the width of the non-coated portion 12a or less. In the roll-pressing step S6, a position that overlaps with the inner end 12a2 of the non-coated portion 12a is pressed by a central portion 73f1 of the rubber portion 73.

The press roll 70 is provided in a position where the press roll 70 can press the non-coated portion 12a. A position of the press roll 70 can be set in accordance with a dimension of the coated portion 12b of the electrode sheet 10. In this embodiment, an end surface 70a of the press roll 70 at an inner side (in the embodiment illustrated in FIG. 6, at left) is located at a slightly more inner side than an end portion 14a of the electrode active material layer 14 at an outer side (in the embodiment illustrated in FIG. 6, at right) of the coated portion 12b of the electrode sheet 10. An end surface 70b of the press roll 70 at the outer side is located at a more outer side than an outer end 12a1 of the non-coated portion 12a of the electrode sheet 10. In this embodiment, the press roll 70 is arranged such that the central portion 73f1 of the rubber portion 73 overlaps with the outer end 12a1 of the non-coated portion 12a.

### Shaft portion 72

The shaft portion 72 includes a columnar portion 72a, a step portion 72b, and an inclined portion 72c.

The columnar portion 72a is an approximately columnar portion a rotation shaft of which is set to be approximately parallel to a rotation shaft of the press roll 70. A diameter of the columnar portion 72a is approximately constant. The columnar portion 72a is provided to extend inward from the outer side of the shaft portion 72 (a side where the end surface 70b is located).

The step portion 72b is a portion with a larger diameter than that of the columnar portion 72a. The step portion 72b is provided at the inner side (a side where the end surface 70a is located) in the shaft portion 72. The step portion 72b is provided in a position where at least a portion thereof overlaps with the inner end 12a2 of the non-coated portion 12a of the electrode sheet 10. In this embodiment, an outer end of the step portion 72b approximately matches the inner end 12a2 of the non-coated portion 12a. The step portion 72b may be configured to extend to a position at a more outer side than the inner end 12a2. The step portion 72b is provided in a position that overlaps with the protective layer 16.

The inclined portion 72c is a portion that connects the columnar portion 72a and the step portion 72b. The inclined portion 72c is a portion inclined from the columnar portion 72a toward the step portion 72b. In this embodiment, the inclined portion 72c is inclined such that a diameter thereof increases as proceeding from the columnar portion 72a toward the step portion 72b. Note that the inclined portion 72c may not be necessarily provided in the shaft portion 72. The rubber portion 73 is wound around an outer peripheral surface 72d of the shaft portion 72.

### Rubber Portion 73

The rubber portion 73 is wound around the outer peripheral surface 72d of the shaft portion 72 at least in an area that contacts the non-coated portion 12a. An inner diameter of the rubber portion 73 corresponds to an outer diameter of the shaft portion 72. In this embodiment, the rubber portion 73 covers an entire portion of the outer peripheral surface (side peripheral surface) 72d of the shaft portion 72. In other words, an inner peripheral surface 73d of the rubber portion 73 extends along the outer peripheral surface 72d of the shaft portion 72. A length of the rubber portion 73 and a length of the shaft portion 72 are approximately same. The rubber portion 73 is formed into an approximately cylindrical shape. An outer diameter of the rubber portion 73 is approximately constant. In this embodiment, the rubber portion 73 includes the thick portion 73a, a thin portion 73b, and an inclined portion 73c. The thick portion 73a is wound around the columnar portion 72a of the shaft portion 72. The thin portion 73b is wound around the step portion 72b of the shaft portion 72. The inclined portion 73c is wound around the inclined portion 72c of the shaft portion 72.

The thick portion 73a is thicker than the thin portion 73b. Although there is no particular limitation on a thickness of the thin portion 73b, the thickness of the thin portion 73b can be set to about 1 mm or more and 30 mm or less. The thickness of the thick portion 73a can be set to be about twice the thickness of the thin portion 73b or more and three time the thickness of the thin portion 73b or less. The inclined portion 73c is inclined such that a thickness thereof decreases as proceeding from the thick portion 73a toward the thin portion 73b. A sum of an outer diameter of the columnar portion 72a and the thickness of the thick portion 73a is approximately same as a sum of an outer diameter of the step portion 72b and the thickness of the thin portion 73b. A sum of an outer diameter of the inclined portion 72c and the thickness of the inclined portion 73c is approximately constant in a shaft direction of the press roll 70. Therefore, a diameter of the press roll 70 is approximately constant.

As described above, the step portion 72b overlaps with the inner end 12a2 of the non-coated portion 12a. The thin portion 73b of the rubber portion 73 is wound around an outer peripheral surface of the step portion 72b. Thus, the thickness of the rubber portion 73 in a position that overlaps with the inner end 12a2 of the non-coated portion 12a is smaller than the thickness of the rubber portion 73 in an area at a more inner side than the position that overlaps with the protective layer 16.

In this embodiment, an end portion of the rubber portion 73 in the width direction is chamfered and a chamfered portion 73e is formed at the end portion. The chamfered portion 73e is a portion having a shape recessed from an outer peripheral surface 73f at the end portion. The chamfered portion 73e has a C-chamfered shape obtained by cutting a corner portion of the rubber portion 73 approximately linearly. Note that there is no particular limitation on the shape of the chamfered portion 73e and the chamfered portion 73e may have, for example, an R-chamfered shape or the like. The chamfered portion 73e is continuously formed in a circumferential direction. The chamfered portion 73e is provided in a position that overlaps with a boundary between the electrode active material layer 14 and the protective layer 16 of the electrode sheet 10. Although there is no particular limitation, the chamfered portion 73e can be formed to extend inward from a position separated a little from the end portion 14a of the electrode active material layer 14 so as not to compress the electrode active material layer 14 in roll pressing. In this embodiment, the chamfered portion 73e is formed to extend inward from a position located about 2 mm outwardly away from the end portion 14a of the electrode active material layer 14.

The electrode sheet manufacturing device 1 according to this embodiment has been described above. Next, an operation performed when the non-coated portion 12a of the electrode sheet 10 is pressed by the roll press machine 50 will be described.

First, as illustrated in FIG. 4, the control device 100 (see FIG. 3) controls the cylinder driving device 83 and the roll driving device 84. The cylinder driving device 83 lowers the rod 81a of the press cylinder 81. The cylinder driving device 83 lowers the rod 81a to a preset position. Thus, the press roll 70 is lowered. At this time, the roll driving device 84 rotates the support roll 60. In this embodiment, as illustrated in FIG. 5, the roll driving device 84 rotates the support roll 60 in the direction of the arrow R1. When the press roll 70 is lowered, a portion of the non-coated portion 12a sandwiched between the support roll 60 and the press roll 70 is compressed.

At this time, as illustrated in FIG. 6, the electrode sheet 10 is pressed by the outer peripheral surface 63f of the rubber portion 63 of the support roll 60 and the outer peripheral surface 73f of the rubber portion 73 of the press roll 70. The rubber portion 73 is formed so as to extend from the end surface 70a at the inner side to the end surface 70b at the outer side in the press roll 70. The rubber portion 73 is provided in the area that contacts the non-coated portion 12a, so that the non-coated portion 12a is pressed across an entire width. Thus, the non-coated portion 12a is extended when passing between the support roll 60 and the press roll 70. At this time, the outer peripheral surface 73f of the rubber portion 73 is pressed also to the protective layer 16. In the position that overlaps with the end portion 14a of the electrode active material layer 14, the chamfered portion 73e is formed in the rubber portion 73, so that a lower surface 14f is less likely to interfere with the electrode active material layer 14 even when the protective layer 16 and the non-coated portion 12a are compressed.

When, in the roll-pressing step S6, the non-coated portion 12a is pressed and is extended, subsequently, the coated portion 12b is rolled in the main pressing step S7.

### Main Pressing Step S7

In the main pressing step S7, the coated portion 12b of the electrode sheet 10 is pressed. In this embodiment, in the main pressing step S7, the coated portion 12b is rolled. The main pressing step S7 can be realized by a roll press machine 90 illustrated in FIG. 3. As illustrated in FIG. 3, the roll press machine 90 is provided downstream of the roll press machine 50 on the conveyance path 18. The roll press machine 90 includes a pair of rolling rolls 91 and 92. Each of the rolling rolls 91 and 92 is an approximately columnar roll that extends along a width direction of the coated portion 12b (see FIG. 4) of the electrode sheet 10. Each of the rolling rolls 91 and 92 is longer than a width of the coated portion 12b.

The pair of rolling rolls 91 and 92 are opposed to each other in the up-down direction with a necessary gap provided therebetween. The gap between the pair of rolling rolls 91 and 92 may be adjusted by an unillustrated driving device (for example, a cylinder device or the like). The gap between the pair of rolling rolls 91 and 92 can be set narrower than a thickness of the electrode sheet 10 (see FIG. 2) (in this embodiment, a total thickness of the current collector 12 and the electrode active material layer 14 formed on both surfaces thereof). For example, the pair of rolling rolls 91 and 92 can be driven in a state where the rolling rolls 91 and 92 contact each other.

Each of the pair of rolling rolls 91 and 92 can be rotated by an unillustrated driving device (for example, an electric motor or the like). The pair of rolling rolls 91 and 92 can be rotated in accordance with conveyance of the electrode sheet 10. For example, the pair of rolling rolls 91 and 92 can be rotationally driven such that a circumferential speed of the outer peripheral surface matches a conveyance speed of the electrode sheet 10. Thus, the electrode sheet 10 passes between the pair of rolling rolls 91 and 92 while being conveyed. At this time, the electrode active material layer 14 of the electrode sheet 10 that has a largest thickness is conveyed while being is compressed by the pair of rolling rolls 91 and 92. When the electrode active material layer 14 is compressed, a portion of the current collector 12 coated with the electrode active material layer 14 is pressurized and, accordingly, the portion of the current collector 12 is extended. At this time, the protective layer 16 and the non-coated portion 12a each of which is thinner than the current collector 12 is not compressed by the pair of rolling rolls 91 and 92.

Note that the main pressing step S7 is not limited to the embodiment described above as long as the electrode active material layer 14 can be compressed. The main pressing step S7 may be performed before the roll-pressing step S6. In this case, the roll press machine 90 can be provided at upstream on the conveyance path 18 and the roll press machine 50 can be provided at downstream on the conveyance path 18.

The electrode sheet 10 is wound by the winding roll 17b after having passed the roll press machine 90. In a manner described above, as for the electrode sheet 10, the current collector 12 of the non-coated portion 12a is extended by the roll press machine 50 and the current collector 12 of the coated portion 12b is extended by the roll press machine 90. Thus, the current collector 12 is stretched in both the non-coated portion 12a and the coated portion 12b, and stretch in the current collector 12 is less likely to be nonuniform. As a result, deformation that occurs when the stretched current collector 12 shrinks is less likely to be nonuniform. Therefore, for example, a defect, such as formation of a wrinkle in the non-coated portion 12a or a fracture of the non-coated portion 12a, is less likely to be caused and quality of the electrode sheet 10 can be increased.

Incidentally, according to a finding of the present inventors, a degree of stretchability of a current collector of an electrode sheet can differ in accordance with a position. In the roll-pressing step, a current collector of a non-coated portion is stretched, but deformation of the rubber portion reduces as proceeding to an end portion of a press roll. Thus, a portion near an electrode active material layer is less likely to be compressed than a portion away from the electrode active material layer. Therefore, the current collector is more difficult to be stretched in a position closer to the electrode active material layer. In the main pressing step, the electrode active material layer is pressed, so that the current collector of the coated portion is stretched and the current collector at a more outer side than a vicinity of the coated portion is difficult to be stretched. Based on the foregoing, there is a trend that, even through the roll-pressing step and the main pressing step, the current collector of the non-coated portion in the vicinity of the electrode active material layer is difficult to be stretched. Specifically, when a protective layer is formed on the current collector, the protective layer is thinner than the electrode active material layer and is difficult to be stretched also in the main pressing step. Thus, a portion of the current collector on which the protective layer is formed is stretched less, as compared to other portions. As a result, stretch of the current collector is likely to be nonuniform.

In the embodiment described above, the electrode sheet manufacturing device 1 includes the conveyance device 17, the support roll 60, the press roll 70, and the driving device (in this embodiment, the cylinder driving device 83) (see FIG. 3 and FIG. 4). The conveyance device 17 conveys the long electrode sheet 10 along the preset conveyance path 18. The support roll 60 is arranged on the conveyance path 18 and supports the first surface (the lower surface 10D) of the electrode sheet 10 that is conveyed along the conveyance path 18 in the width direction. The press roll 70 is arranged so as to be opposed to the support roll 60 on the second surface (the upper surface 10U) of the electrode sheet 10. The cylinder driving device 83 presses the press roll 70 to the support roll 60 with the electrode sheet 10 interposed therebetween. The electrode sheet 10 includes the current collector 12, the electrode active material layer 14, and the protective layer 16. The current collector 12 is formed of a metal foil. The electrode active material layer 14 is formed on the current collector 12. The protective layer 16 is formed along the longitudinal direction of the electrode active material layer 14. The non-coated portion 12a in which the electrode active material layer 14 and the protective layer 16 are not applied is provided in each of the end portions of the electrode sheet 10. The press roll 70 includes the shaft portion 72 and the rubber portion 73. The rubber portion 73 is wound around the outer peripheral surface 72d of the shaft portion 72 at least in the area that contacts the non-coated portion 12a. The thickness of the rubber portion 73 at the position that overlaps with the inner end 12a2 of the non-coated portion 12a is smaller than the thickness of the rubber portion 73 in the area at the more outer side than the position that overlaps with the inner end 12a2.

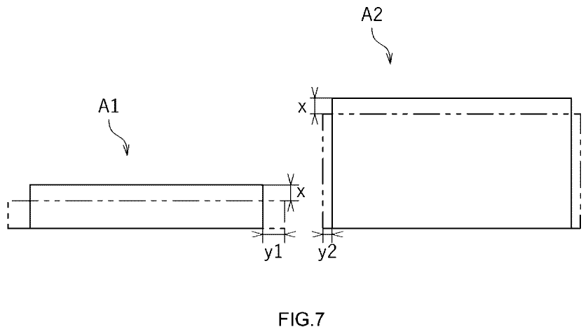

FIG. 7 is a schematic view illustrating a relationship between the thickness of rubber and the deformation amount. Note that FIG. 7 is a view schematically illustrating that the deformation amount of rubber in a surface direction differs in accordance with the thickness of the rubber, and does not necessarily reflect an actual object. According to the finding of the present inventors, as illustrated in FIG. 7, even with a same compression amount x, a deformation amount y1 in a surface direction of a thin rubber A1 (a direction orthogonal to a direction in which the non-coated portion is compressed) is larger, as compared to a deformation amount y2 of a thick rubber A2. According to the electrode sheet manufacturing device 1 described above, the thickness of the rubber portion 73 in the position that overlaps with the protective layer 16 is smaller than the thickness of the rubber portion 73 in the area at the more outer side than the position that overlaps with the inner end 12a2. The non-coated portion 12a can be pressed by a portion of the rubber portion 73 that has a large thickness, and the protective layer 16 at the more inner side than the inner end 12a2 of the non-coated portion 12a can be pressed by a portion of the rubber portion 73 that has a small thickness. Thus, deformation of the rubber portion 73 in the width direction in the position that overlaps with the protective layer 16 is larger than deformation of the rubber portion 73 in the width direction at the more outer side than the position that overlaps with the protective layer 16. Therefore, in the roll-pressing step S6, the current collector 12 on which the protective layer 16 is formed and a portion in a vicinity of the current collector 12 is easily stretched. As a result, in the potions described above, a difference in stretch of the current collector 12 between a portion (the non-coated portion 12a) that is stretched in the roll-pressing step S6 and a portion (a portion of the coated portion 12b on which the electrode active material layer 14 is formed) that is stretched in the main pressing step S7 is likely to be small. Variation in stretch of the current collector 12 is reduced, so that a defect, such as generation of a wrinkle, a fracture, or the like, is less likely to occur in the current collector 12 after being pressed. Thus, the quality of the electrode sheet 10 can be increased.

In the embodiment described above, the shaft portion 72 includes the columnar portion 72a and the step portion 72b. The columnar portion 72a has a columnar shape. The step portion 72b has a larger diameter than that of the columnar portion 72a. The rubber portion 73 includes the thick portion 73a and the thin portion 73b. The thick portion 73a is wound around the outer peripheral surface of the columnar portion 72a. The thin portion 73b is wound around the outer peripheral surface of the step portion 72b. The step portion 72b is provided in the position that overlaps with the protective layer 16. With the configuration described above, the portion of the current collector 12 on which the protective layer 16 is formed and that is difficult to be starched can be locally starched easily. This effect is notable when the thickness of the thick portion 73a is set to twice the thickness of the thin portion 73b or more and three times the thickness of the thin portion 73b or less. Moreover, this effect is more notable when the thickness of the rubber portion 63 and the thickness of the thick portion 73a are about same (for example, the thickness of the rubber portion 63 is 0.9 times the thickness of the thick portion 73a or more and 1.1 times the thickness of the thick portion 73a or less).

In the embodiment described above, the shaft portion 72 includes the inclined portion 72c that is inclined from the columnar portion 72a toward the step portion 72b. Change in stretch of the current collector 12 can be adjusted in a position corresponding to the inclined portion 72c by changing the thickness of the rubber portion 73 in a stepwise manner on the outer peripheral surface of the step portion 72b. Note that there is no particular limitation on an angle of an inclination of the inclined portion 72c. When it is desired to locally stretch the portion in which the protective layer 16 is formed, the angle of the inclination of the inclined portion 72c can be increased. When there is no need to locally stretch the portion in which the protective layer 16 is formed, the angle of the inclination of the inclined portion 72c can be reduced. The angle of the inclined portion 72c can be set in accordance with the widths of the protective layer 16 and the non-coated portion 12a, the thicknesses of the protective layer 16 and the current collector 12, a thickness configuration of the rubber portion 73 corresponding to the columnar portion 72a and the step portion 72b, or the like, as appropriate.

In the embodiment described above, the end portion of the rubber portion 73 is chamfered. Thus, the electrode active material layer 14 is less likely to be compressed by the rubber portion 73. As a result, a load applied to the electrode active material layer 14 can be reduced.

In the embodiment described above, the length of the press roll 70 is longer than the width of the non-coated portion 12a. Therefore, the length of the rubber portion 73 is longer than the width of the non-coated portion 12a. The central portion 73f1 of the rubber portion 73 overlaps with the outer end 12a1 of the non-coated portion 12a. Thus, the non-coated portion 12a is compressed by the central portion 73f1 of the rubber portion 73. According to the finding of the present inventors, the deformation amount in the surface direction (a direction orthogonal to a direction in which the non-coated portion 12 is compressed) increases as proceeding to the central portion 73f1 of the rubber portion 73. Therefore, the non-coated portion 12a is easily stretched also in the outer end 12a1. As a result, variation in stretch in the non-coated portion 12a is likely to be reduced.

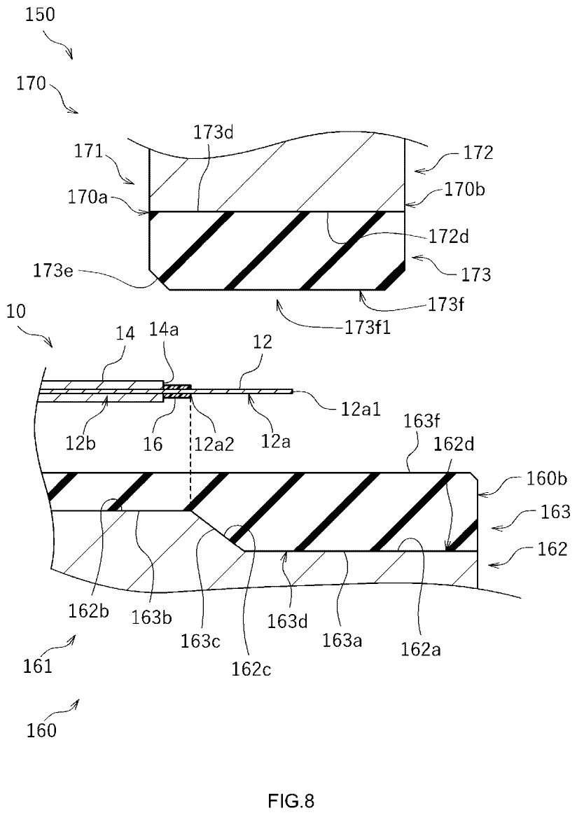

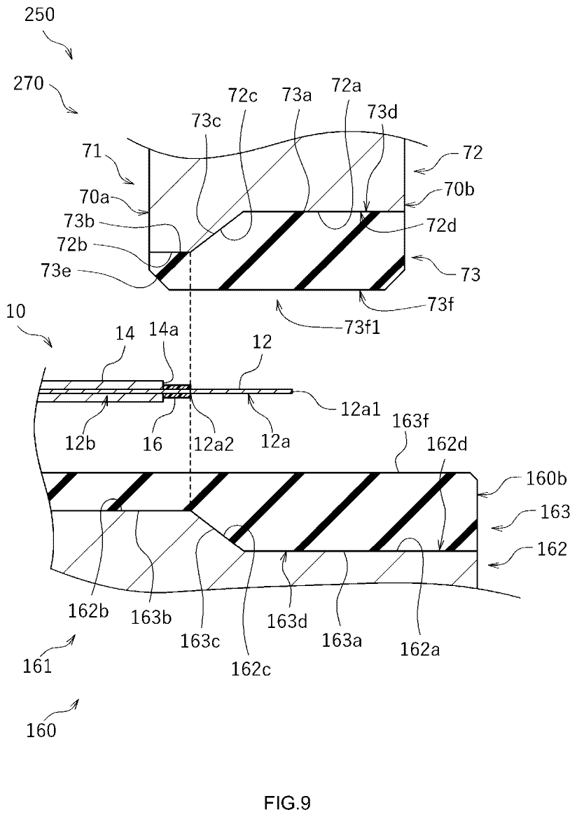

Note that a configuration of the electrode sheet manufacturing device 1 is not limited to the embodiment described above. FIG. 8 is a schematic view illustrating a roll press machine 150 according to another embodiment. FIG. 9 is a schematic view illustrating a press roll machine 250 according to still another embodiment. The roll press machines 150 and 250 can be used for the electrode sheet manufacturing device 1, instead of the roll press machine 50. In each of the roll press machines 150 and 250, each of a support roll and a press roll of the roll press machine may have a different configuration from that described above, and the other components may be same as corresponding components described above.

### Roll Press Machine 150

As illustrated in FIG. 8, the roll press machine 150 includes a support roll 160 and a press roll 170. The support roll 160 and the press roll 170 can be driven by the press pressure regulating mechanism 80 (see FIG. 4).

### Support Roll 160

As illustrated in FIG. 6, the support roll 160 (in this embodiment, a body portion 161) includes a shaft portion 162 and a rubber portion 163.

### Shaft Portion 162

The shaft portion 162 includes a columnar portion 162a, a step portion 162b, and an inclined portion 162c. Although not illustrated, the columnar portion 162a is provided in each of both end portions of the support roll 160. The step portion 162b is sandwiched between the columnar portions 162a provided in the both end portions.

The columnar portion 162a is an approximately columnar portion a rotation shaft of which is set approximately parallel to a rotation shaft of the support roll 160. A diameter of the columnar portion 162a is approximately constant. The columnar portion 162a is provided to extend inward from an outer side of the shaft portion 162 (an end surface 160b side). The columnar portion 162a is provided in a position where at least a portion thereof overlaps with the non-coated portion 12a. The columnar portion 162a extends to a more outer side than the outer end 12a1 of the non-coated portion 12a.

The step portion 162b is a portion that has a larger diameter than that of the columnar portion 162a. The step portion 162b is provided at a more inner side than the columnar portion 162a in the shaft portion 162. The step portion 162b is provided in a position in which at least a portion thereof overlaps with the inner end 12a2 of the non-coated portion 12a of the electrode sheet 10. In this embodiment, an outer end of the step portion 162b approximately matches the inner end 12a2 of the non-coated portion 12a. The step portion 162b may be configured to extend to a more outer side than the inner end 12a2. The step portion 162b is provided in a position that overlaps with the protective layer 16.

The inclined portion 162c is a portion that connects the columnar portion 162a and the step portion 162b. The inclined portion 162c is a portion that is inclined from the columnar portion 162a toward the step portion 162b. In this embodiment, the inclined portion 162c is inclined such that a diameter thereof increases from the columnar portion 162a toward the step portion 162b. Note that the inclined portion 162c may not be necessarily provided in the shaft portion 162. The rubber portion 163 is wound around an outer peripheral surface 162d of the shaft portion 162.

### Rubber Portion 163

The rubber portion 163 is wound around the outer peripheral surface 162d of the shaft portion 162 at least in an area that contacts the non-coated portion 12a. An inner diameter of the rubber portion 163 corresponds to an outer diameter of the shaft portion 162. In this embodiment, the rubber portion 163 covers an entire portion of the outer peripheral surface (side peripheral surface) 162d of the shaft portion 162. In other words, an inner peripheral surface 163d of the rubber portion 163 extends along the outer peripheral surface 162d of the shaft portion 162. A length of the rubber portion 163 and a length of the shaft portion 162 are approximately same. The rubber portion 163 is formed into an approximately cylindrical shape. An outer diameter of the rubber portion 163 is approximately constant. In this embodiment, the rubber portion 163 includes a thick portion 163a, a thin portion 163b, and an inclined portion 163c. The thick portion 163a is wound around the columnar portion 162a of the shaft portion 162. The thin portion 163b is wound around the step portion 162b of the shaft portion 162. The inclined portion 163c is wound around the inclined portion 162c of the shaft portion 162.

The thick portion 163a is thicker than the thin portion 163b. The inclined portion 163c is inclined such that a thickness thereof reduces from the thick portion 163a toward the thin portion 163b. A sum of an outer diameter of the columnar portion 162a and a thickness of the thick portion 163a is approximately same as a sum of an outer diameter of the step portion 162b and a thickness of the thin portion 163b. A sum of an outer diameter of the inclined portion 162c and the thickness of the inclined portion 163c is approximately constant in a shaft direction of the support roll 160. Therefore, a diameter of the support roll 160 is approximately constant.

As described above, the step portion 162b overlaps with the inner end 12a2 of the non-coated portion 12a. The thin portion 163b of the rubber portion 163 is wound around the outer peripheral surface of the step portion 162b. Thus, the thickness of the rubber portion in a position that overlaps with the inner end 12a2 of the non-coated portion 12a is smaller than the thickness of the rubber portion in the area at the more outer side than the position that overlaps with the protective layer 16. The electrode sheet 10 is supported by an outer peripheral surface 163f of the rubber portion 163. The non-coated portion 12a of the electrode sheet 10 is pressed by the press roll 170.

### Press Roll 170

The press roll 170 (in this embodiment, a body portion 171) includes a shaft portion 172 and a rubber potion 173. A dimension of the press roll 170 and a position thereof with respect to the electrode sheet 10 can be made similar to those of the press rolls 70 (see FIG. 6), and therefore, detailed description thereof will be omitted.

### Shaft Portion 172

The shaft portion 172 is an approximately columnar member that extends along the width direction of the electrode sheet 10. In this embodiment, a diameter of the shaft portion 172 is approximately constant. The rubber potion 173 is wound around an outer peripheral surface 172d of the shaft portion 172.

### Rubber Potion 173

The rubber potion 173 is formed into an approximately cylindrical shape. An inner peripheral surface 173d of the rubber potion 173 corresponds to the outer peripheral surface 172d of the shaft portion 172. An inner diameter of the rubber potion 173 is same as an outer diameter of the shaft portion 172. In this embodiment, similar to the outer diameter of the shaft portion 172, the inner diameter of the rubber potion 173 is approximately constant. A thickness of the rubber potion 173 is approximately constant, except for both end portions of the press roll 170 along a shaft. An end portion of the rubber potion 173 in the width direction is chamfered and a chamfered portion 173e is formed at the end portion. A configuration of the chamfered portion 173e can be made similar to that of the chamfered portion 73e (see FIG. 6), and therefore, detailed description thereof will be omitted.

As described above, the support roll 160 includes the shaft portion 162 and the rubber portion 163. The rubber portion 163 is wound around the outer peripheral surface 162d of the shaft portion 162 at least in the area that contacts the non-coated portion 12a. A thickness of the rubber portion 163 in the position that overlaps with the inner end 12a2 of the non-coated portion 12a is smaller than the thickness of the rubber portion 163 in the area at the more inner side than the portion that overlaps with the inner end 12a2. In a manner described above, a portion of the rubber portion that is relatively thin may be provided in the support roll. Also in this case, the non-coated portion 12a can be pressed by the portion of the rubber portion 163 that has a large thickness and the protective layer 16 at the more inner side than the inner end 12a2 of the non-coated portion 12a can be pressed by the portion of the rubber portion 163 that has a small thickness. Thus, similar to the embodiment illustrated in FIG. 6, the current collector 12 can be easily stretched in the current collector 12 on which the protective layer 16 is formed and in the vicinity of the current collector 12. As a result, variation in stretch of the current collector 12 is likely to be reduced. A defect, such as generation of a wrinkle, a fracture, or the like, is less likely to occur in the current collector 12 after being pressed. Thus, the quality of the electrode sheet 10 can be increased.

### Roll Press Machine 250

As illustrated in FIG. 9, the roll press machine 250 includes the support roll 160 and the press roll 270. The support roll 160 and the press roll 270 can be driven by the press pressure regulating mechanism 80 (see FIG. 4). The support roll 160 has a similar configuration to that of the support roll 160 illustrated in FIG. 8, the press roll 270 has a similar configuration to that of the press roll 70 illustrated in FIG. 6, and therefore, detailed description thereof will be omitted.

In this embodiment, in the support roll 160, the thickness of the rubber portion 163 in the position that overlaps with the inner end 12a2 of the non-coated portion 12a is smaller than the thickness of the rubber portion 163 in the area at the more outer side than the position that overlaps with the inner end 12a2. In the press roll 270, the thickness of rubber portion 73 in the position that overlaps with the inner end 12a2 of the non-coated portion 12a is smaller than the thickness of the rubber portion 73 in the area at the more outer side than the position that overlaps with the inner end 12a2. Thus, the portion (the protective layer 16) at the more inner side than the inner end 12a2 of the non-coated portion 12a is compressed by the both the rubber portions 73 and 163 of the support roll 160 and the press roll 270 each of which is relatively thin. Thus, a total deformation amount of each of the rubber portions 73 and 163 can be caused to be larger. The deformation amount of each of the rubber portions 73 and 163 is increased, so that the current collector 12 can be easily stretched at the current collector 12 on which the protective layer 16 is formed and in the vicinity of the current collector 12.

Note that, in the roll press machine 250 illustrated in FIG. 9, an outer end of the thin portion 163b of the rubber portion 163 of the support roll 160 and an outer end of the thin portion 73b of the rubber portion 73 of the press roll 270 are set an approximately same position. However, a configuration of the roll press machine 250 is not limited thereto. In at least one of the rubber portion 163 of the support roll 160 and the rubber portion 73 of the press roll 270, the thickness of the rubber potion in the position that overlaps with the inner end 12a2 of the non-coated portion 12a may be smaller than the thickness of the rubber portion in the area at the more outer side than the position that overlaps with the inner end 12a2. In this embodiment, the shaft portion 162 of the support roll 160 is a second shaft portion and the rubber portion 163 is a second rubber portion.

The technology disclosed herein has been described above in various forms. However, the embodiments described above or the like shall not limit the present disclosure, unless specifically stated otherwise. Various changes can be made to the technology disclosed herein, and each of components and processes described herein can be omitted as appropriate or can be combined with another one or other ones of the components and the processes as appropriate, unless a particular problem occurs. The present specification includes disclosure set forth in the following items.

First Item: An electrode sheet manufacturing device that manufactures an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, the electrode sheet manufacturing device including a conveyance device that conveys the electrode sheet along a preset conveyance path, a support roll that is arranged on the conveyance path and supports a first surface of the electrode sheet that is conveyed along the conveyance path along the width direction, a press roll arranged to be opposed to the support roll on a second surface of the electrode sheet, and a driving device that presses the press roll to the support roll with the electrode sheet interposed therebetween, in which the press roll includes a shaft portion and a rubber portion wound around an outer peripheral surface of the shaft portion at least in an area that contacts the non-formed portion, and a thickness of the rubber portion in a position that overlaps with an inner end of the non-formed portion is smaller than a thickness of the rubber portion in an area at a more outer side than the position that overlaps with the inner end.

Second Item: The electrode sheet manufacturing device according to the first item, in which the support roll includes a second shaft portion and a second rubber portion wound around an outer peripheral surface of the second shaft portion at least in the area that contacts the non-formed portion, and a thickness of the second rubber portion in the portion that overlaps with the inner end of the non-formed portion is smaller than a thickness of the second rubber portion in the area at the more outer side than the position that overlaps with the inner end.

Third Item: An electrode sheet manufacturing device that manufactures an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, the electrode sheet manufacturing device including a conveyance device that conveys the electrode sheet along a preset conveyance path, a support roll that is arranged on the conveyance path and supports a first surface of the electrode sheet that is conveyed along the conveyance path along the width direction, a press roll arranged to be opposed to the support roll on a second surface of the electrode sheet, and a driving device that presses the press roll to the support roll with the electrode sheet interposed therebetween, in which the support roll includes a shaft portion and a rubber portion wound around an outer peripheral surface of the shaft portion at least in an area that contacts the non-formed portion, and a thickness of the rubber portion in a position that overlaps with an inner end of the non-formed portion is smaller than a thickness of the rubber portion in an area at a more outer side than the position that overlaps with the inner end.

Fourth Item: The electrode sheet manufacturing device according to any one of the first to third items, in which the shaft portion includes a columnar portion having a columnar shape and a step portion having a diameter of which is larger than that of the columnar portion, the rubber portion includes a thick portion wound around an outer peripheral surface of the columnar portion and a thin portion wound around an outer peripheral surface of the step portion, and the step portion is provided in a position that overlaps with the protective layer.

Fifth Item: The electrode sheet manufacturing device according to the fourth item, in which the shaft portion includes an inclined portion that is inclined from the columnar portion toward the step portion.

Sixth Item: The electrode sheet manufacturing device according to the fourth or fifth item, in which a thickness of the thick portion is twice a thickness of the thin portion or more and three times the thickness of the thin portion or less.

Seventh Item: The electrode sheet manufacturing device according to any one of the fourth to sixth items, in which the support roll includes a second shaft portion and a second rubber portion wound around an outer surface of the second shaft portion at least in the area that contacts the non-formed portion, and a thickness of the second rubber portion is 0.9 times a thickness of the thick portion or more and 1.1 times the thickness of the thick portion or less.

Eighth Item: The electrode sheet manufacturing device according to any one of the first to seventh items, in which an end portion of the rubber portion is chamfered.

Ninth Item: The electrode sheet manufacturing device according to any one of the first to eighth items, in which a length of the rubber portion is longer than a width of the non-formed portion, and a central portion of the rubber portion overlaps with the outer end of the non-formed portion.

Tenth Item: An electrode sheet manufacturing method including a preparing step of preparing an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, and a roll-pressing step of pressing the electrode sheet with the electrode sheet interposed between the support roll and the press roll while conveying the electrode sheet along a preset conveyance path, in which the press roll includes a shaft portion and a rubber portion wound around an outer peripheral surface of the shaft portion at least in an area that contacts the non-formed portion, a thickness of the rubber portion in a position that overlaps with an inner end of the non-coated portion is smaller than a thickness of the rubber portion in an area at a more outer side than the position that overlaps with the inner end, and in the roll-pressing step, the electrode sheet is pressed using the press roll.

Eleventh Item: The electrode sheet manufacturing method according to the tenth item, in which the support roll includes a second shaft portion and a second rubber portion wound around an outer peripheral surface of the second shaft portion at least in the area that contacts the non-formed portion, and a thickness of the second rubber portion in the portion that overlaps with the inner end of the non-formed portion is smaller than a thickness of the second rubber portion in the area at the more outer side than the position that overlaps with the inner end.

Twelfth Item: An electrode sheet manufacturing method including a preparing step of preparing an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, and a roll-pressing step of pressing the electrode sheet with the electrode sheet interposed between the support roll and the press roll while conveying the electrode sheet along a preset conveyance path, in which the support roll includes a shaft portion and a rubber portion wound around an outer peripheral surface of the shaft portion at least in an area that contacts the non-formed portion, a thickness of the rubber portion in a position that overlaps with an inner end of the non-formed portion is smaller than a thickness of the rubber portion in an area at a more outer side than the position that overlaps with the inner end, and in the roll-pressing step, the electrode sheet is pressed using the support roll.

Thirteenth Item: The electrode sheet manufacturing method according to any one of the tenth to twelfth items, in which the shaft portion includes a columnar portion having a columnar shape and a step portion having a diameter of which is larger than that of the columnar portion, the rubber portion includes a thick portion wound around an outer peripheral surface of the columnar portion and a thin portion wound around an outer peripheral surface of the step portion, and the step portion is provided in a position that overlaps with the protective layer.

Fourteenth Item: The electrode sheet manufacturing method according to the thirteenth item, in which the shaft portion includes an inclined portion that is inclined from the columnar portion toward the step portion.

Fifteenth Item: The electrode sheet manufacturing method according to the thirteenth or fourteenth item, in which a thickness of the thick portion is twice a thickness of the thin portion or more and three times the thickness of the thin portion or less.

Sixteenth Item: The electrode sheet manufacturing method according to any one of the thirteenth to fifteenth items, in which the support roll includes a second shaft portion and a second rubber portion wound around an outer surface of the second shaft portion at least in the area that contacts the non-formed portion, and a thickness of the second rubber portion is 0.9 times a thickness of the thick portion or more and 1.1 times the thickness of the thick portion or less.

Seventeenth Item: The electrode sheet manufacturing method according to any one of the tenth to sixteenth items, in which an end portion of the rubber portion is chamfered.

Eighteenth Item: The electrode sheet manufacturing method according to any one of the tenth to seventeenth items, in which a length of the rubber portion is longer than a width of the non-formed portion, and in the roll-pressing step, a position that overlaps with the outer end of the non-formed portion is pressed by a central portion of the rubber portion.

What is claimed is:

1. An electrode sheet manufacturing device that manufactures an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, the electrode sheet manufacturing device comprising:
a conveyance device that conveys the electrode sheet along a preset conveyance path;
a support roll that is arranged on the conveyance path and supports a first surface of the electrode sheet that is conveyed along the conveyance path along the width direction;
a press roll arranged to be opposed to the support roll on a second surface of the electrode sheet; and
a driving device that presses the press roll to the support roll with the electrode sheet interposed therebetween,
wherein
the press roll includes a shaft portion and a rubber portion wound around an outer peripheral surface of the shaft portion at least in an area that contacts the non-formed portion, and
a thickness of the rubber portion in a position that overlaps with an inner end of the non-formed portion is smaller than a thickness of the rubber portion in an area at a more outer side than the position that overlaps with the inner end.

2. The electrode sheet manufacturing device according to claim 1, wherein
the support roll includes a second shaft portion and a second rubber portion wound around an outer peripheral surface of the second shaft portion at least in the area that contacts the non-formed portion, and
a thickness of the second rubber portion in the portion that overlaps with the inner end of the non-formed portion is smaller than a thickness of the second rubber portion in the area at the more outer side than the position that overlaps with the inner end.

3. An electrode sheet manufacturing device that manufactures an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer, the electrode sheet manufacturing device comprising:
a conveyance device that conveys the electrode sheet along a preset conveyance path;
a support roll that is arranged on the conveyance path and supports a first surface of the electrode sheet that is conveyed along the conveyance path along the width direction;
a press roll arranged to be opposed to the support roll on a second surface of the electrode sheet; and
a driving device that presses the press roll to the support roll with the electrode sheet interposed therebetween,
wherein
the support roll includes a shaft portion and a rubber portion wound around an outer peripheral surface of the shaft portion at least in an area that contacts the non-formed portion, and
a thickness of the rubber portion in a position that overlaps with an inner end of the non-formed portion is smaller than a thickness of the rubber portion in an area at a more outer side than the position that overlaps with the inner end.

4. The electrode sheet manufacturing device according to claim 1, wherein
the shaft portion includes a columnar portion having a columnar shape and a step portion having a diameter of which is larger than that of the columnar portion,
the rubber portion includes a thick portion wound around an outer peripheral surface of the columnar portion and a thin portion wound around an outer peripheral surface of the step portion, and
the step portion is provided in a position that overlaps with the protective layer.

5. The electrode sheet manufacturing device according to claim 4, wherein
the shaft portion includes an inclined portion that is inclined from the columnar portion toward the step portion.

6. The electrode sheet manufacturing device according to claim 4, wherein
a thickness of the thick portion is twice a thickness of the thin portion or more and three times the thickness of the thin portion or less.

7. The electrode sheet manufacturing device according to claim 4, wherein
the support roll includes a second shaft portion and a second rubber portion wound around an outer surface of the second shaft portion at least in the area that contacts the non-formed portion, and
a thickness of the second rubber portion is 0.9 times a thickness of the thick portion or more and 1.1 times the thickness of the thick portion or less.

8. The electrode sheet manufacturing device according to claim 1, wherein
an end portion of the rubber portion is chamfered.

9. The electrode sheet manufacturing device according to claim 1, wherein
a length of the rubber portion is longer than a width of the non-formed portion, and
a central portion of the rubber portion overlaps with the outer end of the non-formed portion.

10. An electrode sheet manufacturing method comprising:
a preparing step of preparing an electrode sheet including a current collector formed of a long metal foil, a non-formed portion set along a length direction in a preset position of the current collector in a width direction, an electrode active material layer formed in a portion of the current collector excluding the non-formed portion, and a protective layer formed along a length direction of the electrode active material layer; and
a roll-pressing step of pressing the electrode sheet with the electrode sheet interposed between the support roll and the press roll while conveying the electrode sheet along a preset conveyance path,
wherein
the press roll includes a shaft portion and a rubber portion wound around an outer peripheral surface of the shaft portion at least in an area that contacts the non-formed portion,
a thickness of the rubber portion in a position that overlaps with an inner end of the non-coated portion is smaller than a thickness of the rubber portion in an area at a more outer side than the position that overlaps with the inner end, and
in the roll-pressing step, the electrode sheet is pressed using the press roll.

11. The electrode sheet manufacturing method according to claim 10, wherein
the support roll includes a second shaft portion and a second rubber portion wound around an outer peripheral surface of the second shaft portion at least in the area that contacts the non-formed portion, and
a thickness of the second rubber portion in the portion that overlaps with the inner end of the non-formed portion is smaller than a thickness of the second rubber portion in the area at the more outer side than the position that overlaps with the inner end.

12. The electrode sheet manufacturing method according to claim 10, wherein
the shaft portion includes a columnar portion having a columnar shape and a step portion having a diameter of which is larger than that of the columnar portion,
the rubber portion includes a thick portion wound around an outer peripheral surface of the columnar portion and a thin portion wound around an outer peripheral surface of the step portion, and
the step portion is provided in a position that overlaps with the protective layer.

13. The electrode sheet manufacturing method according to claim 12, wherein
the shaft portion includes an inclined portion that is inclined from the columnar portion toward the step portion.

14. The electrode sheet manufacturing method according to claim 12, wherein
a thickness of the thick portion is twice a thickness of the thin portion or more and three times the thickness of the thin portion or less.

15. The electrode sheet manufacturing method according to claim 12, wherein
the support roll includes a second shaft portion and a second rubber portion wound around an outer surface of the second shaft portion at least in the area that contacts the non-formed portion, and
a thickness of the second rubber portion is 0.9 times a thickness of the thick portion or more and 1.1 times the thickness of the thick portion or less.

16. The electrode sheet manufacturing method according to claim 10, wherein
an end portion of the rubber portion is chamfered.

17. The electrode sheet manufacturing method according to claim 10, wherein
a length of the rubber portion is longer than a width of the non-formed portion, and
in the roll-pressing step, a position that overlaps with the outer end of the non-formed portion is pressed by a central portion of the rubber portion.
